(19) United States
(12) Patent Application Publication
(10) Pub. No.: US 2008/0187337 A1
(43) Pub. Date: Aug. 7, 2008

(54) IMAGE FORMING APPARATUS AND ELECTRIC DISCHARGE REDUCTION METHOD THEREOF

(75) Inventors: Jin-cheol KIM, Suwon-si (KR); Hyun-sun Jung, Seongnam-si (KR); Yoo-seok Yang, Yongin-si (KR); Yong-baek Yoo, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/970,681

(22) Filed: Jan. 8, 2008

(30) Foreign Application Priority Data
Feb. 6, 2007 (KR) 2007-12239

(51) Int. Cl. G03G 15/06

(52) U.S. Cl. 399/55

(57) ABSTRACT

An image forming apparatus includes an image former which comprises a photosensitive body and a developing device to apply a developer to the photosensitive body, a power supply which supplies developing voltage to the developing device, a detector which detects a density of an image formed by the image former, and a controller which controls the power supply to adjust a level of the developing voltage if the detected density is out of a permissible range.

### CROSS-REFERENCE TO RELATED APPLICATIONS

This application claims priority from Korean Patent Application No. 10-2007-0012239, filed on Feb. 6, 2007, in the Korean Intellectual Property Office, the disclosure of which is incorporated herein by reference.

### BACKGROUND OF THE INVENTION

1. Field of the Invention

The present general inventive concept relates to an image forming apparatus and an electric discharge reduction method thereof, and more particularly, to an image forming apparatus which controls a level of power supplied to a developing device, and an electric discharge reduction method thereof.

2. Description of the Related Art

An image forming apparatus forms an image based on printing data. The image forming apparatus may form a printing image by an inkjet method, an electrophotographic method, etc. The electrophotographic image forming apparatus forms an electrostatic latent image on a photosensitive body by light scanned by a laser scanning unit (LSU). Then, a toner of a developing device is transferred to the photosensitive body according to the electrostatic latent image formed on the photosensitive body. A transfer roller transfers the developed toner to a print medium to output a desired printing image.

The electrophotographic image forming apparatus may perform the developing operation by a non-contact method in which a distance exists between the photosensitive body and the developing device. In the non-contact developing method, a toner which has a polarity moves due to a potential difference between the developing device and the photosensitive body.

The image density and an electric discharge are determined by the distance and the potential difference between the developing device and the photosensitive body. Generally, a potential difference exists between two electrodes, leaving a dielectric medium therebetween. If the potential difference exceeds a specific threshold value to cause breakdown of insulation of the dielectric medium, an electric discharge occurs, i.e., an undesired current flow between the two electrodes. If the electric discharge occurs, the toner moving toward the photosensitive body is interrupted, thereby causing errors in the printing image.

FIG. 1 illustrates a relationship between a distance D and air pressure P between the developing device and the photosensitive body, and a breakdown voltage Vbr. As illustrated therein, the breakdown voltage Vbr is proportional to a product of the distance D and the air pressure P between the developing device and the photosensitive body. The breakdown voltage Vbr is calculated by the following Formula 1:

Vbr=312.5+6.2PD [Formula 1]

Here, PD is the product of a distance D and air pressure P between he developing device and the photosensitive body. The distance D and the potential difference between the developing device and the photosensitive body may vary depending on assembly process differences, environmental factors and the wear of the image forming apparatus due to long-term usage. Therefore, the breakdown voltage Vbr also changes accordingly. The conventional image forming apparatus may include an electric potential sensor to detect an electric potential with the sensor and may control a level of developing voltage supplied to the developing device. However, the electric potential sensor is expensive, thereby lowering price competitiveness.

### SUMMARY OF THE INVENTION

The present general inventive concept provides an image forming apparatus which controls a level of developing voltage supplied to a developing device as a function of a density detected by a density sensor and prevents or reduces the chance of an electric discharge regardless of assembly process differences and external environments, avoiding the need of an expensive sensor such as an electric potential sensor or a distance sensor, and an electric discharge reduction method thereof.

Additional aspects and utilities of the present general inventive concept will be set forth in part in the description which follows and, in part, will be obvious from the description, or may be learned by practice of the present general inventive concept.

The foregoing and/or other aspects of the present general inventive concept can be achieved by providing an image forming apparatus, including an image former which includes a photosensitive body and a developing device to apply a developer to the photosensitive body, a power supply which supplies a developing voltage to the developing device, a detector which detects a density of an image formed by the image former, and a controller which controls the power supply to adjust a level of the developing voltage if the detected density is out of a permissible range.

The controller may control the image former to form the image corresponding to at least one detection pattern to detect the density.

The image corresponding to the detection pattern may have at least 50% toner area coverage (TAC).

The controller may control the level of the developing voltage of a subsequent printing of an image with one TAC based on at least one detection pattern having another TAC.

The controller may control the image former to form the image corresponding to the detection pattern on at least one of a conveying belt conveying a print medium and the photosensitive body.

The controller may lower or raise at least one of a maximum developing voltage and a minimum developing voltage supplied to the developing device in predetermined steps.

The foregoing and/or other aspects of the present general inventive concept can also be achieved by providing an electric discharge reduction method of an image forming apparatus which includes an image former having a photosensitive body and a developing device applying a developer to the photosensitive body, the method including: supplying a voltage to the developing device, forming an image by the image former, detecting a density of the formed image, and altering a level of developing voltage supplied to the developing device if the detected density is outside a permissible range.

The forming of the image may include forming the image corresponding to at least one detection pattern to detect the density.

The image corresponding to the detection pattern may have at least 50% toner area coverage (TAC).

The controlling of the level of the developing voltage may include altering the developing voltage of a subsequent printing of an image with one TAC based on at least one detection pattern having another TAC.

The forming of the image may include forming the image corresponding to the detection pattern on at least one of a conveying belt conveying a print medium and the photosensitive body.

The altering of the level of the developing voltage may include lowering or raising at least one of a maximum developing voltage and a minimum developing voltage supplied to the developing device in predetermined steps.

The foregoing and/or other aspects and utilities of the present inventive concept may also be achieved by providing a printer including a photosensitive body, a developing device including developer, a voltage source including an output voltage which is applied between the photosensitive body and the developing device to thereby transfer developer from the developing device to the photosensitive body to create an image, an image transfer path to transfer the image on the photosensitive body to a print medium to an output of the printer, a detector located along the image transfer path to detect a density of the image, and a controller to control the output voltage and to alter the output voltage for additional printing operations in response to an output of the detector.

The printer may print a test pattern image including sub-images printed with different toner area coverage, and the test pattern image may be printed during a calibration phase.

The foregoing and/or other aspects and utilities of the present inventive concept may also be achieved by a method of calibrating a printer may include creating an image within the printer, detecting a density of the image, and determining whether or not to alter a voltage output to an image forming element of the printer in response to the detected density.

The detecting of the density of the image may include detecting the density of a test pattern on a printing medium, a conveying belt or a photosensitive body.

The foregoing and/or other aspects and utilities of the present inventive concept may also be achieved by providing an image forming apparatus including a developing device to develop an image with a developer, a power supply to supply a developing voltage to the developing device, and a controller to adjust the developing voltage according to a density of a developed image.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings of which:

FIG. 1 illustrates a breakdown voltage as a function of the product of a distance and an air pressure between a developing device and a photosensitive body in an image forming apparatus;

FIGS. 2A and 2B are block diagrams of an image forming apparatus according to an exemplary embodiment of the present general inventive concept;

FIGS. 3A and 3B illustrate detection pattern images of the image forming apparatus according to an exemplary embodiment of the present general inventive concept;

FIGS. 4A and 4B illustrate an output voltage detected as per the detection pattern image of the image forming apparatus according to an exemplary embodiment of the present general inventive concept; and

FIG. 5 is a flowchart which illustrates an electric discharge reduction method of the image forming apparatus according to an exemplary embodiment of the present general inventive concept.

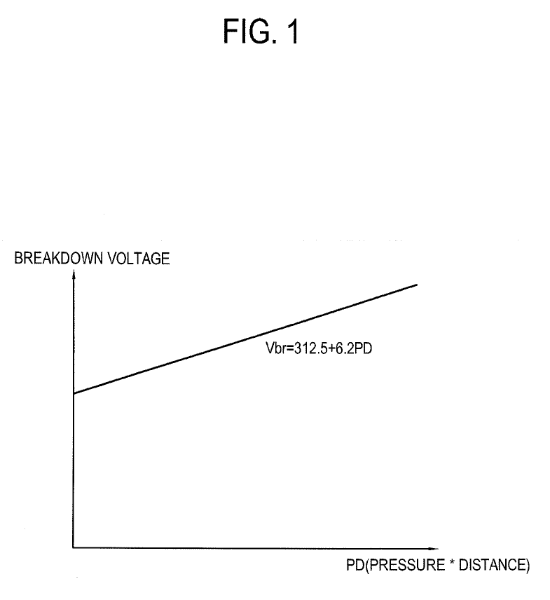

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

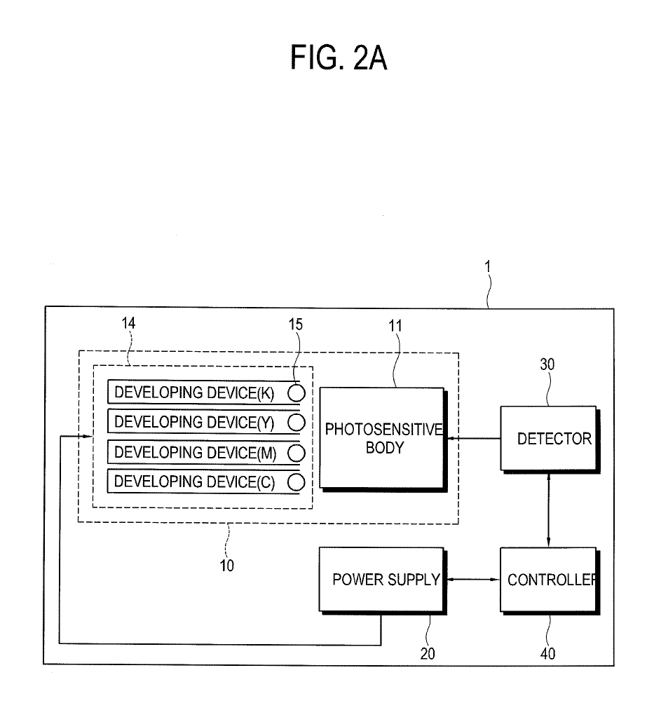

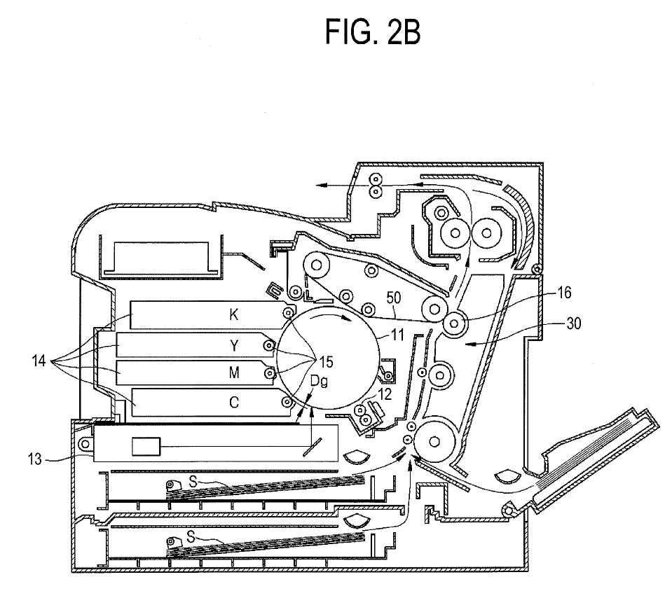

FIGS. 2A and 2B are block diagrams illustrating configuration of an image forming apparatus 1 according to one exemplary embodiment of the present general inventive concept. In this example, the image forming apparatus 1 includes an image former 10, a power supply 20, a detector 30, and a controller 40. The image forming apparatus 1 may include an electrophotographic color printing apparatus.

The image former 10 may include a photosensitive body 11, a charging roller 12 which charges the photosensitive body 11 with a uniform electric potential, an exposer 13 which forms an electrostatic latent image on the charged photosensitive body 11 by scanning light corresponding to printing data thereto, a developing device 14 which includes a developer and applies the developer to the electrostatic latent image formed on the photosensitive body 11 using developing rollers 15, and a transfer roller 16 which transfers the toner to the charged photosensitive body.

In this example, the developing device 14 includes developing rollers 15. Alternatively, the developing device 14 may include a belt type developing device.

The power supply 20 supplies a developing voltage to the developing device 14 to transfer the toner to the photosensitive body 11. The power supply 20 according in this example superimposes AC power and DC voltages to supply the developing voltage to the developing device 14, thereby controlling maximum and minimum values and duty ratio of the developing voltage.

The detector 30 detects a density of an image by estimating the amount of the developer on the image formed by the image former 10. The detector 30 may include a color toner density (CTD) sensor. In this example, the detector 30 may be adjacent to a conveying belt 50 conveying the print medium, however the detector 30 may also be placed adjacent to the photosensitive body 11, or at another location where it is able to detect the density of the image.

The detector 30 includes a light source (not shown) which preferably emits a predetermined amount of light onto the conveying belt 50 or the photosensitive body 11, and a light receiver (not shown) which estimates the amount of light reflected from the conveying belt 50 or the photosensitive body 11. The detector 30 may thereby detect the density of the image and transmit information regarding the same by providing an output signal in accordance with the reflected light amount detected.

The controller 40 receives the output signal from the detector 30. The controller 40 controls the power supply 20 to adjust the level of the developing voltage supplied to the developing device 14 if the range of density detected by the detector 30 is outside a permissible predetermined range.

If the developer has a negative polarity, the controller 40 may control the level of the developing voltage supplied to the developing device 14 by altering Vmin. Vmin refers to a minimum voltage level supplied to the developing device 14 during subsequent printing operations after the image former is calibrated. In this case, because the developer has a negative polarity, Vmin should have a larger magnitude than Vmax. If the developer has a positive polarity, the controller 40 may control the level of the developing voltage supplied to the developing device 14 by altering Vmax, the maximum voltage level during normal printing operations. As another example, the controller 40 may control the level of the developing voltage based on Vmean, an average value of the developing voltage level supplied to the developing device 14.

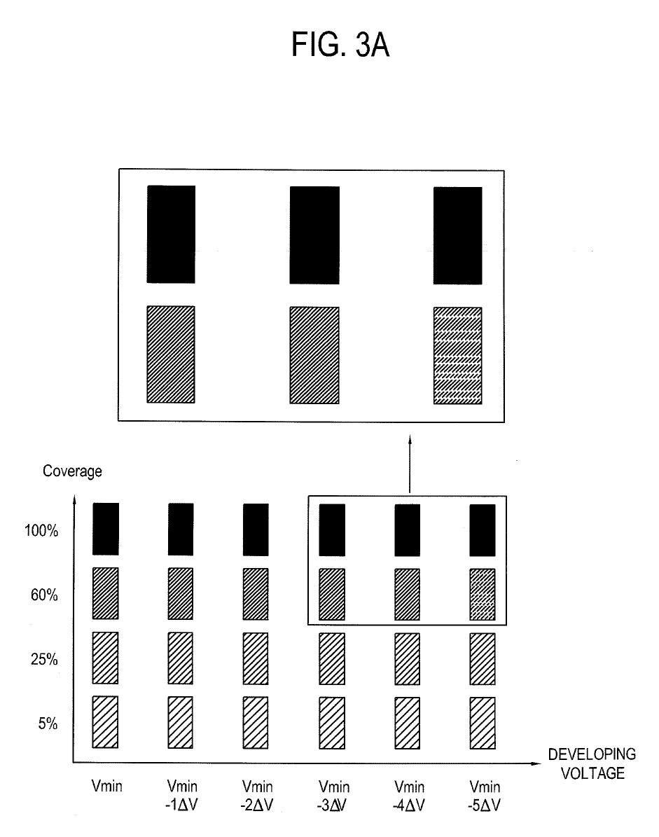

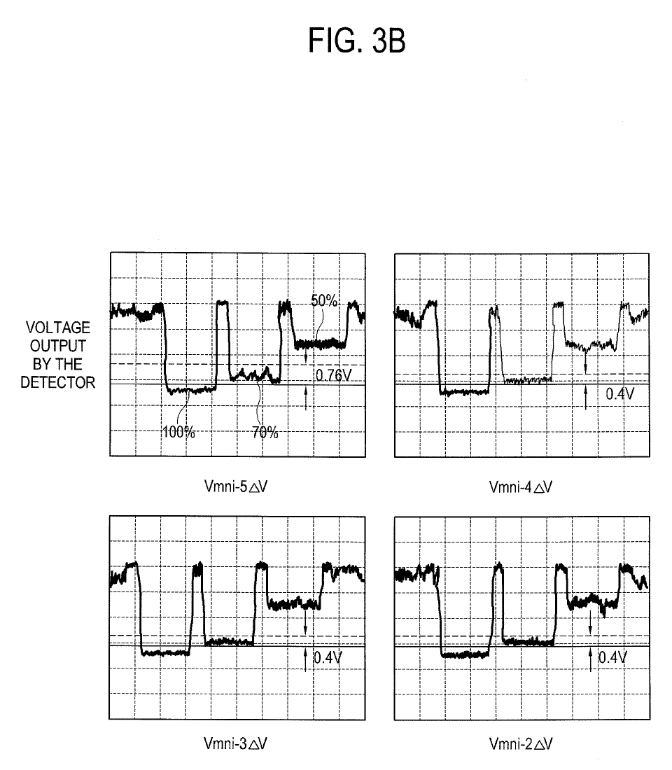

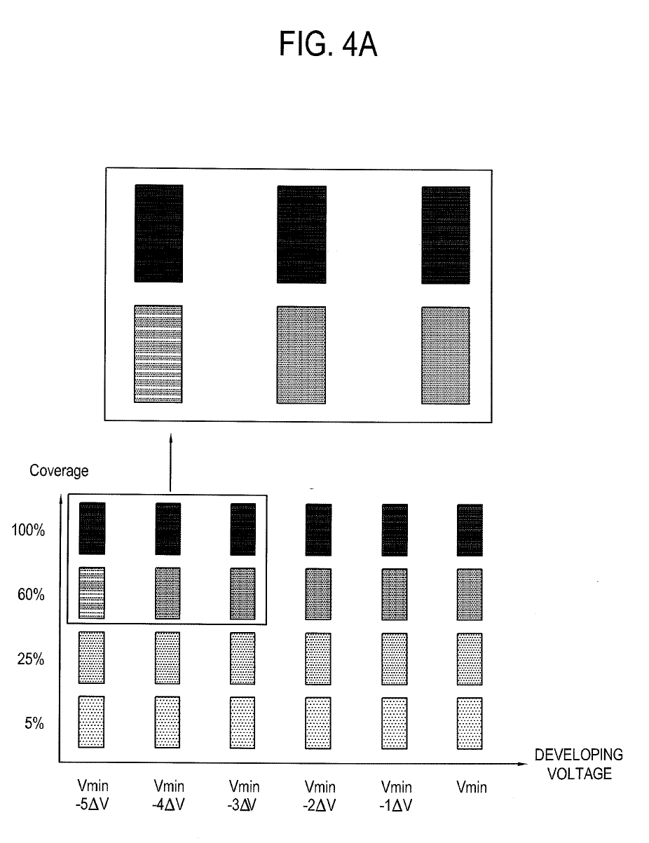

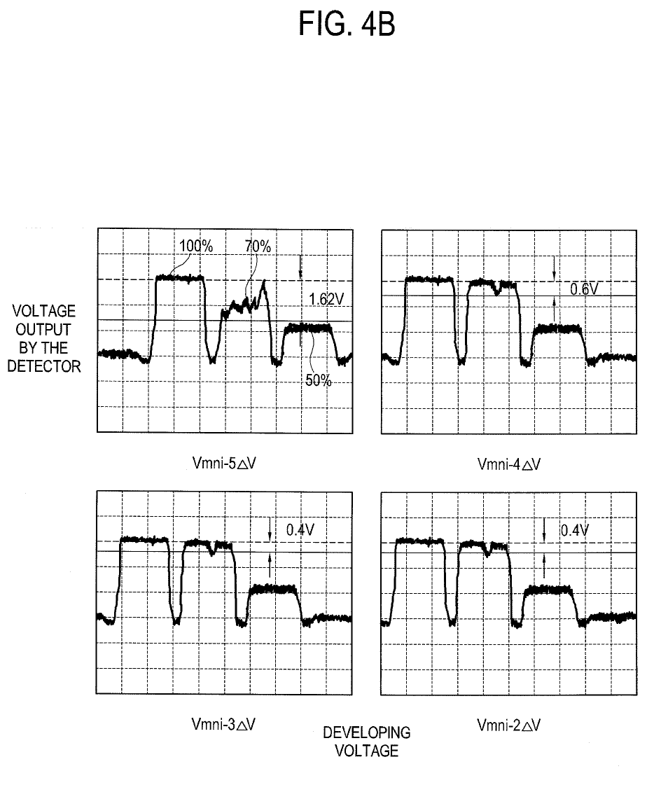

The process of altering the level of the developing voltage supplied to the developing device 14 by the controller 40 will be described with reference to Tables 1 and 2, and FIGS. 3 and 4.

TABLE 1

| | | | Vmni- | Vmni- | Vmni- | Vmni- | Vmni- |
|---|---|---|---|---|---|---|---|
| | | Vmni | ΔV | 2ΔV | 3ΔV | 4ΔV | 5ΔV |
| 100% coverage | Electric | No | No | No | No | Yes | Yes |
| | discharge | | | | | | |
| | Potential | <0.4 V | <0.4 V | <0.4 V | <0.4 V | <0.4 V | <0.4 V |
| | difference | | | | | | |
| 60% coverage | Electric | No | No | No | No | No | Yes |
| | discharge | | | | | | |
| | Potential | <0.4 V | <0.4 V | <0.4 V | <0.4 V | <0.4 V | 0.76 V |
| | difference | | | | | | |

Table 1 illustrates outputs from detector 30, corresponding to a measured toner density, used to determine whether an electric discharge occurs. Specifically, a detection pattern image having portions with a toner area coverage (TAC) 100% and 60%, respectively, is printed several times with different levels of the developing voltage supplied to the developing device 14. Here, the detection pattern corresponds to a black image from the black (K) ink, although other inks may be used to form the image (e.g., cyan (C), magenta (M), yellow (Y)).

In this example, the Vmin of the developing voltage applied to the developing device 14 was altered from an initial value Vmni (an initial Vmin) to Vmni-5ΔV in steps of ΔV to print a corresponding detection pattern image. Table 1 shows the range of the potential of a signal output from detector 30 corresponding to the measured toner density of each detection pattern image, denoted on Table 1 as a potential difference. Depending on this potential difference, it is determined whether or not an electric discharge has occurred. As shown in Table 1, it is determined that an electric discharge occurs when the level of the developing voltage is Vmni-4ΔV and Vmni-5ΔV in the case of the 100% TAC detection pattern images. It is determined that an electric discharge occurs when the level of the developing voltage is Vmni-5ΔV in the case of the 60% TAC detection pattern image. In this particular example, the output voltage Vmni is −1,300V and ΔV is 50V.

FIG. 3A illustrates the detection pattern image corresponding to black depending on a TAC and the level of the minimum developing voltage Vmin supplied to the developing device 14. FIG. 3B illustrates the level of the voltage output by the detector 30 as the level of the developing voltage Vmin supplied to the developing device 14 is adjusted, here showing detector outputs with Vmin of, Vmni-2ΔV, Vmni-3ΔV, Vmni-4ΔV and Vmni-5ΔV.

As illustrated in FIG. 3A, if the TAC is 60% and if the level of the developing voltage is Vmni-5ΔV, a part of the detection pattern image broken up (having uneven toner distribution). This is due to an electric discharge.

FIG. 3B illustrates the voltage outputs of detector 30 (highlighted by the red boxes) as it measures the toner density for some of the 60% TAC detection pattern images of 3A. As illustrated in FIG. 3B, if the level of the developing voltage supplied to the developing device 14 is Vmni-2ΔV, Vmni-3ΔV or Vmni-4ΔV, the range of the output voltage from detector 30 is about 0.4V. However, if the level of the developing voltage supplied to the developing device 14 is Vmni-5ΔV, the range of the voltage output from the detector 30 is about 0.76V. In this example, if the output voltage difference is about 0.4V or above, the controller 40 determines that the toner moving toward the photosensitive body 11 has been interrupted by the electric discharge. The controller therefore controls the level of the developing voltages supplied to the developing device 14 in future printing operations (after this calibration) to avoid the electric discharge.

Note that if the TAC is 100%, the controller 40 does may not be able to detect the toner density difference between a discharging area and a non-discharging area of the detection pattern images as the output voltage from the detector 30 may be saturated. To address this case, detection pattern images of varying TAC may be monitored by the detector 30 and controller 40. In one example, detection pattern images with varying Vmin applied to the developing device 14 may initially be printed with a TAC of 50%, and these detection pattern images may be reprinted with gradually increasing TACs.

TABLE 2

| | | | Vmni- | Vmni- | Vmni- | Vmni- | Vmni- |
|---|---|---|---|---|---|---|---|
| | | Vmni | ΔV | 2ΔV | 3ΔV | 4ΔV | 5ΔV |
| 100% coverage | Electric | No | No | No | No | Yes | Yes |
| | discharge | | | | | | |
| | Potential | <0.4 V | <0.4 V | <0.4 V | <0.4 V | <0.4 V | <0.4 V |
| | difference | | | | | | |
| 60% coverage | Electric | No | No | No | No | Yes | Yes |
| | discharge | | | | | | |
| | Potential | <0.4 V | <0.4 V | <0.4 V | <0.4 V | 0.6 V | 1.62 V |
| | difference | | | | | | |

Table 2 illustrates the range of the output of the detector 30 and whether the electric discharge occurs when the TAC of the detection pattern image is 100% and 60%, respectively, with different levels of the developing voltage supplied to the developing device 14. In this example, the detection pattern image was created by the magenta developing device 14 (M).

As shown in Table 2, the electric discharge is determined to occur when the level of the developing voltage applied to the developing device 14 is Vmni-4ΔV or Vmni-5ΔV, in the case of a 60% TAC detection pattern.

FIG. 4A illustrates the detection pattern image corresponding to the magenta developing device, printed with various TAC and various levels of the minimum developing voltage Vmin supplied to the developing device 14. FIG. 4B illustrates the level of the voltage output by the detector 30 corresponding to those detection pattern images of FIG. 4A (highlighted by the red boxes) with a TAC of 60% printed with a developing device 14 having a minimum developing voltage Vmin of, Vmni-2ΔV, Vmni-3ΔV, Vmni-4ΔV and Vmni-5ΔV. Here, FIGS. 4A and 4B include boxes of particular regions to illustrate graphs opposite to graphs of FIGS. 3A and 3B in shape and different from the graphs of FIGS. 3A and 3B in output voltage. The different output voltage and opposite shape represent a difference of reflected light.

The pattern of the output voltage in FIG. 4A is symmetrical to that of the output voltage in FIG. 3A centering around an axis of the developing voltage, since the light emitted by the detector 30 is specularly-reflected corresponding to the black image while the light is diffusedly-reflected corresponding to the color image.

As illustrated in FIG. 4B, if the level of the developing voltage supplied to the developing device 14 is Vmni-2ΔV or Vmni-3ΔV, the range of voltage output by the detector 30 upon detecting the detection pattern image is less than 0.4V. If the level of the developing voltage supplied to the developing device 14 is Vmni-4ΔV, the range of voltage output from the detector 30 upon detecting the detection pattern image is about 0.6V. If the level of the developing voltage supplied to the developing device 14 is Vmni-5ΔV, the range of voltage output by detector 30 upon detecting the detection pattern image is about 1.62V.

If the range of voltage output by the detector 30 upon detecting the detection pattern image is 0.4V and above, the controller 40 determines that the toner moving toward the photosensitive body 11 has been interrupted by an electric discharge and accordingly controls the level of the developing voltage supplied to the developing device 14 in future printing operations (after this calibration process) to avoid the electric discharge. For example, controller 40 may set Vmin of the magenta (M) developing device 14 to Vmni-3ΔV.

In the foregoing description, the controller 40 controls the level of the developing voltage supplied to the developing device 14 by adjusting Vmin with Vmax fixed. However, the controller 40 may control the level of the developing voltage supplied to the developing device 14 by adjusting Vmax with Vmin fixed. As another example, the controller 40 may control Vmin and/or Vmax based on Vmean.

The level of the developing voltage at which the electric discharge starts occurring in the detection pattern of 100% TAC may be lower than that at which the electric discharge starts occurring in the detection pattern of 60% TAC. However, as noted above, determining electric discharge with detection patterns of higher TAC may be difficult due to saturation of the output of the detector 40. Thus, the controller 40 may determine the level of the developing voltage at which the electric discharge starts occurring in the 100% TAC printing operations, based on the level of the developing voltage at which the electric discharge starts occurring in the detection pattern of 60% TAC. Here, the percentage of the TAC can be adjusted or changed according to the intensity of the light illuminated from the exposer 13.

For example, if it is detected that the electric discharge occurs at −1,550V for a detection pattern having a TAC of 60%, the controller 40 controls the level of the developing voltage so that the minimum value of the developing voltage supplied to the developing device 14 becomes −1,600V (e.g., −1,550V-ΔV ) for subsequent 100% TAC printing operations.

Thus, the controller 40 may determine the level of the developing voltage at which the electric discharge starts occurring in the case of one TAC detection pattern, and based on this, control the level of the developing voltage supplied to the developing device 14 for printing operations for another TAC.

The controller 40 may form an image on the photosensitive body 11 as well as on the conveying belt 50 conveying the print medium, and control the level of the developing voltage supplied to the developing device 14 by detecting the density of the image (via detector 30) formed on the photosensitive body 11, the conveying belt 50, the print medium or some other location along the image transfer path.

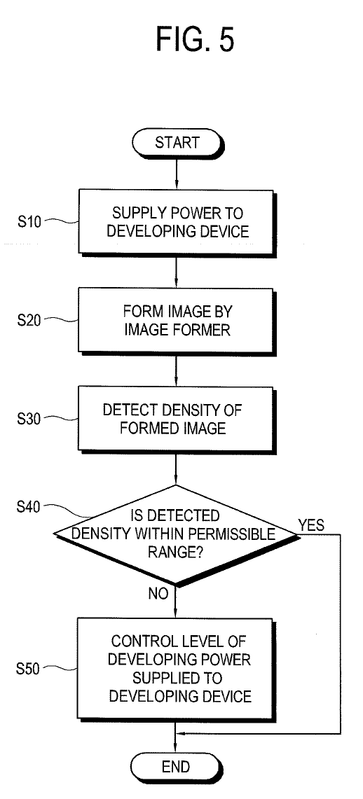

FIG. 5 illustrates one example of a method of avoiding or reducing the electric discharge of the image forming apparatus 1.

In operation S10, voltage is supplied to a developing device. This may be done with a controller controlling a power supply, for example. In operation S20, an image is formed by the image former according to the voltage supplied at operation S10. The controller may control this operation as well, if desired. The image formed at operation S20 may correspond to at least one detection pattern to detect the density. The TAC of the image corresponding to the detection pattern may be 50% and above. The image may be formed on a photosensitive body and transferred to a conveying belt conveying the print medium prior to transfer to the print medium.

In operation S30, the density of the image formed at operation S20 is detected. This may be done with a detector placed at a desired location along the image transfer path, for example, adjacent a photosensitive body, a conveying belt or a location of the print medium transfer path after the print medium receives the image. A controller may be used to monitor the output of the detector to determine the density of the image. In operation S40, the density detected at operation S30 is evaluated to determine whether or not it is within a permissible range. For example, a controller may determine the range of outputs from the detector and determine if this range is within a predetermined value. If it is determined at operation S40 that the detected density is outside of the permissible range, the level of the developing voltage supplied to the developing device for subsequent operations is altered. For example, the absolute value of the minimum or maximum voltage supplied to the developing device may be lowered. For example, these voltages may be lowered to the breakdown voltage or below.

The level of the developing voltage may be altered for subsequent printing operations of one TAC percentage based upon the detection of density of an image of a different TAC percentage. Thus, an electric discharge may be prevented or minimized even with variances of assembly processes and/or external operating environments without requiring an expensive sensor such as a potential sensor or a distance sensor.

As described above, an image forming apparatus and method to control a level of developing voltage supplied to a developing device according to a density detected by a density sensor and prevents or minimizes an electric discharge even with variances of assembly processes and/or external operating environments without requiring an expensive sensor such as a potential sensor or a distance sensor.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An image forming apparatus, comprising:
an image former which comprises a photosensitive body and a developing roller to apply a developer to the photosensitive body;
a power supply which supplies a developing voltage to the developing roller;
a detector which detects a density of an image formed by the image former; and
a controller which controls the power supply to adjust a level of the developing voltage if the detected density is outside a permissible range.

2. The image forming apparatus according to claim 1, wherein the controller controls the image former to form at least one detection pattern image to detect the density.

3. The image forming apparatus according to claim 2, wherein at least part of the detection pattern image has at least 50% toner area coverage (TAC).

4. The image forming apparatus according to claim 3, wherein the controller controls the level of the developing voltage of a subsequent image having a first TAC in response to an output of the detector detecting a density of a detection pattern image having a second, different TAC.

5. The image forming apparatus according to claim 1, wherein the controller controls the image former to form a detection pattern image on at least one of a conveying belt conveying a print medium and the photosensitive body.

6. The image forming apparatus according to claim 1, wherein the controller lowers or raises the level at least one of a maximum developing voltage and a minimum developing voltage supplied to the developing roller in one or more predetermined steps.

7. An electric discharge minimizing method of an image forming apparatus which comprises an image former having a photosensitive body and a developing roller applying a developer to the photosensitive body, the method comprising:
supplying a voltage to the developing roller;
forming an image by the image former;
detecting a density of the formed image; and
controlling a level of developing voltage supplied to the developing roller if the detected density is outside of a permissible range.

8. The method according to claim 7, wherein the forming of the image comprises forming at least one detection pattern image to detect the density.

9. The method according to claim 8, wherein the detection pattern image has at least 50% toner area coverage (TAC).

10. The method according to claim 9, wherein the controlling of the level of the developing voltage comprises controlling the level of the developing voltage of a subsequent image having a first TAC in response to detecting a density of a detection pattern image having a second, different TAC.

11. The method according to claim 7, wherein the forming of the image comprises forming a detection pattern image on at least one of a conveying belt conveying a print medium and the photosensitive body.

12. The method according to claim 7, wherein the controlling of the level of the developing voltage comprises lowering or raising at least one of a maximum developing voltage and a minimum developing voltage supplied to the developing roller in one or more predetermined steps.

13. An image forming apparatus, comprising:
a photosensitive body;
a developing device including a developer and a developing roller;
a voltage source including an output voltage which is applied between the photosensitive body and the developing roller to transfer the developer from the developing roller to the photosensitive body to create an image;
an image transfer path to transfer the image on the photosensitive body to a print medium to an output of the image forming apparatus;
a detector located along the image transfer path to detect a density of the image; and
a controller to alter the output voltage for a printing operation in response to an output of the detector.

14. The image forming apparatus of claim 13, wherein the controller alters a maximum magnitude of the output voltage of the voltage source during additional printing operations in response to the output of the detector.

15. The image forming apparatus of claim 13, wherein the output voltage includes an alternating voltage element, and the controller alters a value of at least one of the peaks of the alternating voltage element in response to the output of the detector.

16. The image forming apparatus of claim 13, wherein the output voltage creates a negative alternating voltage at the developing roller as compared to the photosensitive body, and the controller alters the minimum voltage applied to the developing roller.

17. The image forming apparatus of claim 13, wherein the image is a test pattern image including sub-images printed with different toner area coverage, the test pattern image being printed during a calibration phase.

18. The image forming apparatus of claim 17, wherein the additional printing operations occur after the calibration phase.

19. The image forming apparatus of claim 13, wherein the output of the detector is a signal corresponding to the density of the image detected by the sensor, and wherein the controller determines whether or not to alter the output voltage for additional printing as a function of the range of the signal.

20. The image forming apparatus of claim 19, wherein the controller determines whether or not to alter the output voltage for additional printing operations if a magnitude of the range of the signal exceeds a predetermined value.

21. The image forming apparatus of claim 20, wherein the controller alters a maximum magnitude of the output voltage of the voltage source during additional printing operations in response to the output of the detector.

22. The image forming apparatus of claim 20, wherein the output voltage includes an alternating voltage element, and the controller alters a value of at least one of the peaks of the alternating voltage element in response to the output of the detector.

23. The image forming apparatus of claim 19, wherein the controller alters a maximum magnitude of the output voltage of the voltage source during additional printing operations in response to the output of the detector.

24. The image forming apparatus of claim 19, wherein the output voltage includes an alternating voltage element, and the controller alters a value of at least one of the peaks of the alternating voltage element in response to the output of the detector.

25. The image forming apparatus of claim 19, wherein the detector is positioned adjacent the photosensitive body to detect a density of the image while the image is on the photosensitive body.

26. A method of calibrating an image forming apparatus, comprising:
creating an image within the image forming apparatus;
detecting a density of the image; and
determining whether or not to alter a voltage output to an image forming element of the image forming apparatus in response to the detected density.

27. The method of claim 26, wherein the determining whether or not to alter the voltage output includes determining whether or not to alter a voltage pattern applied between a developer and a photosensitive body.

28. The method of claim 26, wherein the determining whether or not to alter the voltage output includes determining whether or not to alter a range of an alternating voltage applied to a developer during subsequent image printing.

29. The method of claim 26, wherein the determining whether or not to alter the voltage output includes determining whether or not to alter at least one of a minimum or maximum voltage level of the voltage applied to the developer during subsequent image printing.

30. The method of claim 26, wherein the detecting of the density of the image includes detecting the density of a test pattern on a printing medium.

31. The method of claim 26, wherein the detecting of the density of the image includes detecting the density of a test pattern on a conveying belt.

32. The method of claim 26, wherein the detecting of the density of the image includes detecting the density of a test pattern on a photosensitive body.

33. The method of claim 26, wherein the detecting of the density of the image includes detecting the density of a test pattern including portions with different toner area coverage percentages.

34. The method of claim 26, wherein
the detecting of the density of the image includes creating a signal in response to the detected density of the image; and
the determining whether or not to alter the voltage output includes comparing a magnitude of a range of the signal with a predetermined value to determine whether or not to alter the voltage output to an image forming element of the image forming apparatus.

35. An image forming apparatus comprising:
a developing roller to develop an image with a developer;
a power supply to supply a developing voltage to the developing roller; and
a controller to adjust the developing voltage according to a density of a developed image.
